(19) United States
(12) Patent Application Publication
(10) Pub. No.: US 2026/0252635 A1
(43) Pub. Date: Aug. 27, 2026

(54) Customized Embedding Recommendations for Document Corpus

(71) Applicant: Unstructured Technologies, Inc., Wilmington, DE (US)

(72) Inventors: Jia Shen, Lemont, PA (US); Renyu Li, San Diego, CA (US); Crag Wolfe, San Jose, CA (US); Ryan Nikolaidis, Portland, OR (US)

(21) Appl. No.: 19/063,775

(22) Filed: Feb. 26, 2025

(51) Int. Cl. G06F 16/93; G06F 18/2415

(52) U.S. Cl. CPC G06F 16/93; G06F 18/2415

(57) ABSTRACT

In one embodiment, a method includes splitting a set of documents into a group of document chunks; determining a representative sample of the group of document chunks; and selecting a set of chunks from the representative sample of the group of document chunks. The method further includes, for each selected chunk, generating, by a trained AI model, a number of statements including (1) a first statement that is classified as relevant to the selected chunk and (2) a second statement that is classified as not relevant to the selected chunk; for each selected chunk and each of the multiple of statements, determining, by each of multiple embedding models, a similarity score between that statement and the selected chunk; and selecting, based on the determined similarity scores, at least one embedding model to use to embed a corpus of documents.

### TECHNICAL FIELD

This application generally relates to generating customized embedding recommendations for embedding a corpus of electronic documents.

### BACKGROUND

Information stored electronically is often used for retrieval and content generation. For example, a bank employee may want to look up information regarding bank guidelines for storing sensitive customer information, or an attorney preparing a merger agreement may want to start with a previous agreement to use as a template, rather than drafting the agreement from scratch. Information is often stored electronically in many different forms and in many different file formats, and information stored in an electronic file is generally referred to as a “document,” regardless of the format and form that the electronic file takes. Many entities store thousands of documents or millions of documents, and some store even more.

Accurate information retrieval and content generation can require information from one portion of a document, from multiple portions of a document, or even from multiple documents. Techniques that recognize text on a page, such as optical character recognition, may be used for storing text in searchable format, for example so that keyword searches may be run on documents, but such techniques rely on elementary language matching (e.g., searching for exact words or phrases, or for particular words that are within a particular distance from other words) and do not take into account semantic meaning of a document's contents. In addition, such techniques do not generate content (e.g., answers) from information contained in electronic documents.

### BRIEF DESCRIPTION OF THE DRAWINGS

FIG. 1 illustrates an example method for recommending an embedding model to use to embed a document corpus for downstream AI-assisted tasks.

FIG. 2 illustrates an example computing system.

### DESCRIPTION OF EXAMPLE EMBODIMENTS

Artificial intelligence (AI) technology can provide many types of assistance for users exploring a corpus of electronic documents. For example, large language models (LLMs) can receive natural-language queries (e.g., spoken or written queries) and can provide natural-language output based on the contents of documents in the corpus. For instance, LLMs can answer queries on the contents of documents, or generate a template for a particular kind of document from documents in a corpus. As another example, machine-learning models can be used to find many different kinds of patterns within a corpus of documents. AI assistance is revolutionary both in terms of the services it can provide (e.g., natural-language understanding and generation) and in its ability to provide information services on what can be a huge corpus of documents (e.g., a set of millions of documents).

However, creating a system that provides AI-assistance on a particular corpus of documents is a complex and difficult task. For example, for an LLM to answer queries on a user's corpus of documents, the LLM needs to semantically understand the contents of the documents in a way that corresponds to the information requested in the query. This is difficult for multiple reasons. For instance, documents take many different formats (e.g., spreadsheets, text-based documents, web-based documents, email documents, images, etc.), and different formats may define a document's contents very differently. Documents in a corpus therefore typically need to be normalized in a consistent way before an LLM can semantically understand the document's contents. In addition, a document's semantic meaning depends on what portion of the document is being considered, what content is in that portion, and how big that portion is.

For example, a 1,000+ page cookbook may generally describe techniques for preparing food. But that overview characterization of the entire cookbook is not useful for answering the specific question of “how does one make the top of a crème brûlée crunchy?” or “how long should I blanch broccoli for an antipasto salad?” Likewise, a document may contain different types of content, such as images, tables, and text, each of which provides information in different ways. For example, suppose a page of a cookbook textually and graphically describes a procedure for rolling bread dough. Asking “what information does this page show?” is a complex question that does not have a single answer, and both the text and images would need to be considered when providing an answer. In addition, both the portion of the page being considered and the relevancy of the information should be considered. For instance, “use a roller that has a light brown color” is unlikely to be relevant information for rolling bread dough, even if an image illustrates a light brown roller. Likewise, the portion or page being considered affects what information is being communicated. For example, a particular image and corresponding sentence that describes the need to sprinkle flour on the surface used to roll the dough provides more specific, but also more limited, information than would three full pages devoted to techniques for rolling bread dough.

Creating a robust system for AI-assisted tasks on a document corpus typically requires accessing the document corpus, splitting each document into portions (also referred to document chunks), and then computationally representing the semantic meaning within each document chunk. For instance, semantic meaning may be represented by embedding chunks, using any of a number of embedding approaches to represent the content in the chunk as a vector in an embedding space. These embeddings can then be stored in a database and accessed by an AI model during runtime for an AI-assisted task (e.g., to answer a user query on the document corpus).

However, actually implementing this process requires choosing among many different approaches and parameters values, each of which affects downstream performance on the AI-assisted tasks. As just one example, the choice of how and where to divide a document into chunks affects how those chunks are semantically understood by an embedding model. As another example, the choice of embedding model itself affects downstream task performance. Complicating this endeavor is the fact that accurate performance, and thus the corresponding approach to implement, varies based on the user's specific document corpus, and even on the specific task the user wishes to perform (e.g., information retrieval vs. content generation). And finally, creating a database from a document corpus that results in accurate run-time performance takes significant resources, including compute and monetary resources, and therefore using trial-and-error to test many different approaches for creating an AI-usable database from the document corpus is prohibitively expensive in terms of money, compute resources, and time.

This disclosure focuses on techniques for embedding a user's document corpus in a database so that an AI model (e.g., an LLM) can later access the database and perform AI-assisted tasks. For example, an LLM may receive a user query in natural-language form, embed the query using the same embedding approach as was used to embed the document corpus, and then intelligently return a query answer based on the query and corpus embeddings. The techniques described herein determine a recommended embedding approach on the user's specific corpus of documents, focusing on the downstream AI-task performance on that corpus. The recommend embedding approach may be a particular embedding model or may be ranked list of embedding models, along with (in particular embodiment) a description of why a particular model provides good downstream performance, from which the user can choose the embedding model to use to embed their document corpus.

As explained herein, many different embedding approaches exist, and these different approaches have varying performance levels for different document corpuses. It is almost always infeasible for a user to simply test each embedding approach on their document corpus-for instance, embedding a corpus and testing the embedding-induced effect on downstream task performance can take weeks and cost several million dollars for large corpuses, making it impractical to test even several embedding approaches, much less to test several hundred and select the best approach for the user's particular corpus and desired AI-assisted tasks. In addition, once embedding is performed, it is very costly to re-do embedding with a different embedding approach due to poor downstream tasks performance.

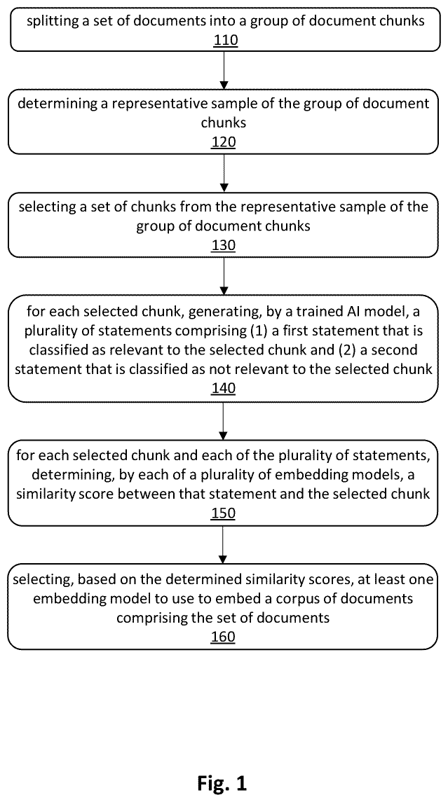

In contrast, the techniques described herein can test, accurately analyze embedding model efficacy, and accurately recommend a particular embedding approach that performs best for a particular corpus of documents at greatly reduced compute and resource cost (e.g., in a matter of minutes). FIG. 1 illustrates an example method for recommending an embedding model to use to embed a document corpus for downstream AI-assisted tasks. Step 110 of the example method of FIG. 1 includes splitting a set of documents into a group of document chunks. In particular embodiments, the set of documents may be a representative set of documents of a larger (often much larger) corpus of documents. For example, an end user may have thousands, hundreds of thousands, or millions (or more) of documents in a corpus. The corpus of documents may include many different file types.

As discussed above, embedding can be a resource-intensive process in terms of time, monetary resources, and computer resources. Evaluating many different embedding models (or even more than one model, for large document corpuses) on a corpus of documents is therefore often infeasible. The corpus of documents may therefore be split into a smaller, but representative set of documents. Representative documents may be determined based on the file structure of the documents, the contents of the documents, or both. For example, if a corpus includes many financial 10-K reports for a company, then only one or a few 10-Ks are sufficient to represent the larger set of 10-K documents, because such documents typically have a fixed format and meaning, even though the actual values set forth in the 10-K vary from 10-K to 10-K. In particular embodiments, an AI model such as an LLM may be used to summarize each document, which then defines that document's content and file structure.

Representative documents may be determined by, for example, clustering documents based on their similarities (i.e., based on the similarity of their contents and file structures). The number of clusters may be fixed or varied. Once document clustering has been performed for a set of documents, then the clustered set may be sampled to generate the set of documents discussed in step 110 of the example method of FIG. 1. For instance, the clustered set may be randomly sampled. In particular embodiments, sampling may be performed according to one or more statistical requirements (e.g., that the percentage of each cluster's contribution to the sampled set is statistically similar to the percentage of the documents in that cluster to the overall corpus of documents). By creating a representative sample, a large corpus of documents may be drastically reduced to the representative set of documents.

In step 110, the set of documents (often a representative set of documents of a larger corpus, although smaller corpuses may not require representative sampling) is then divided into document chunks. Chunks are smaller portions of each document so that embedding is tailored to the content within a particular chunk rather than to the entire contents of a document, making embedding more semantically meaningful. There are many different approaches to chunking a document. For example, a fixed size (e.g., a fixed number of characters) with a sliding window may be used to create chunks. For instance, 100 characters may be defined as a chunk, with each chunk consisting of sliding the 100-character window by 10 characters, moving forward in reading order. However, this approach does not track with the semantic meaning of the content of a chunk, e.g., a chunk may include the last few characters of one section and the first few characters of a different section, and those sections may relate to entirely different topics.

Another approach to chunking uses document contents to determine appropriate chunks. For example, a document may be divided into document elements, each of which has a classification label such as image, text (paragraphs, sentences, etc.), header, page number, title, table, and so on, that is based on the element's content. The document elements may be used to identify semantically related chunks. For instance, a chunk may start with (or following) a “title” element that identifies the title of a section of the document. The chunk may then include content until a stopping condition, such as a certain number of characters is reached or until another “title” element is reached. This disclosure contemplates that other chunking approaches may be used.

Step 120 of the example method of FIG. 1 includes determining a representative sample of the group of document chunks. In other words, once document chunks are created from the documents in the (typically representative) set of documents, then a representative sample of chunks is generated. For instance, once document chunks have been created, then chunks may be clustered into groups based on their content, type (e.g., as determined by an element's classification label), or both. Any suitable clustering approach (e.g., TF-IDF) may be used to generate clusters, and typically there will be many clusters generated from the document chunks.

The representative sample of document chunks may be obtained by, for instance, randomly sampling the clustered group of chunks until a desired number of chunks are obtained. In particular embodiments, the chunks in the representative sample may statistically match the distribution of the chunks in the clusters.

Step 130 of the example method of FIG. 1 includes selecting a set of chunks from the representative sample of the group of document chunks. In particular embodiments, the selected set of chunks may be randomly sampled from the representative sample. As described more fully herein, step 130 may be repeated in particular embodiments that select embedding models based on multiple analyses of embedding model performance.

Step 140 of the example method of FIG. 1 includes for each selected chunk, generating, by a trained AI model, multiple statements including at least (1) a first statement that is classified as relevant to the selected chunk and (2) a second statement that is classified as not relevant to the selected chunk. The AI model may be, for example, a trained LLM, and step 140 may include submitting a prompt to the trained LLM in order to tune the LLM to the statement-generating task. For instance, an untrained LLM architecture may initially be trained on a large corpus of strings, resulting in a trained LLM architecture that can process natural language input and can output natural language. This trained LLM architecture may then be used to generate the multiple statements referenced in step 140, and may be fine tuned to that specific task.

The first statement is relevant to the content in the chunk, while the second statement is not relevant to the content in the chunk. In particular embodiments, the statements may be questions. For example, suppose that a chunk describes how to change the engine oil of a car. A relevant first statement may be “How do I change the engine oil in a car?” while an irrelevant second statement may be “What is the best roofing for a tropical climate?” In particular embodiments, more than these two statements may be generated for each chunk, with varying degrees of relevancy to the chunk at issue. For example, a third statement may be of neutral relevance, such as “What annual maintenance should be performed on a car?” As a result of step 140, each chunk is associated with multiple statements that are classified as relevant to the chunk, irrelevant to the chunk, and (in particular embodiments) something in between.

As discussed above, in particular embodiments an LLM may be used to generate the multiple statements for each selected chunk. For example, each chunk may be passed to the LLM, along with a prompt explaining, among other things, that the LLM should generate a first statement (e.g., a question) that is semantically relevant to the chunk and a second statement that is not semantically relevant to the chunk. The particular statements may be identified by a particular label (relevant, neutral or moderately relevant, irrelevant) that is defined in the prompt.

As described above, the techniques described herein intentionally generate not only statements that are relevant to the chunk, but also statements that are not relevant to the chunk (and, in particular embodiment, statements that are somewhere in between). This approach improves the downstream step of evaluating model performance, as many embedding models are trained to, and have a bias towards, embedding inputs similarly. In other words, an embedding model fed only semantically related chunks and statements will tend to score well on that exercise, even if the model overall does a poor job of distinguishing between irrelevant and relevant content, which is a key part of accurately performing AI-assisted tasks. However, in the techniques described herein, the intentional generation of irrelevant statements helps ensure that embedding models' scores accurately reflect their performance on the ultimate AI-assisted task.

Step 150 of the example method of FIG. 1 includes, for each selected chunk and each of the plurality of statements, determining, by each of multiple embedding models, a similarity score between that statement and the selected chunk. Embedding models embed input by vectorizing the input into a vector in an embedding space. Embedding models may use various scoring methods to determine similarity between two pieces of input, for example by using distance in the embedding space as a proxy for similarity. Examples of scoring approaches include cosine similarity, the L₂ or L₁ distance-based metrics, and so on. Embedding models that use the same scoring function will still almost always embed content differently, due to differences in how those models are trained.

Step 160 of the example method of FIG. 1 includes selecting, based on the determined similarity scores, at least one embedding model to use to embed a corpus of documents that includes the set of documents (which, as described above, may be a representative sample of a much larger document corpus). In particular embodiments, step 160 includes picking the top-scoring embedding model based on the models' performance on embedding chunks and corresponding questions generated in step 140. In particular embodiments, step 160 includes selecting the top n performing models and providing an identification of those models to the end user. For example, the user may request that the method of FIG. 1 be performed, for instance via a user interface, and the top n scoring models may be surfaced to the end user, for instance via that user interface. In particular embodiments, additional information, such as the ranking associated with each presented model, certain statistical measures of the embedding models' performance (for instance, the ML metrics described below), and/or an explanation of each presented model's strength and weakness or an explanation of why each presented model was highly ranked may be presented to the end user, so that the end user can choose which embedding model to use to embed the corpus of documents and perform downstream AI-assisted tasks on that corpus.

In particular embodiments, step 160 may include selecting at least one embedding model based on how well an embedding model's similarity scores for statement/chunk pairs match the similarity of the statement/chunk pair. For example, the similarity of a statement/chunk pair may be determined by the label (e.g., relevant, irrelevant, etc.) given to that pair when the statement was generated. For embodiments that use a distance score to represent the similarity score, then an accurate embedding model should generate relatively lower scores (closer distances) for similar statement/chunk pairs and relatively higher scores for dissimilar statement/chunk pairs.

In particular embodiments, and as described more fully below, an LLM may be used to evaluate and score embedding models. For example, an LLM may be asked to evaluate the already generated statement/chunk pairs and analyze the similarity between a statement and a chunk in a pair, for example based on semantic meaning, implication and inference, sentiment and tone, and/or coherence and conciseness. The LLM may then be asked to evaluate the embedding models' similarity scores for statement/chunk pairs relative to the similarity determinations made by that LLM. This also serves as a check on the statement generation process, e.g., by ensuring that statements generated as relevant to a chunk are in fact determined to be similar by a downstream LLM.

In particular embodiments, step 160 may include analyzing the embedding model scores based on how those models perform with respect to the statement categories used during step 140. For example, statement/chunk pairs may be grouped into relevant pairs, neutral pairs, and irrelevant pairs, in embodiments that use those three labels. The embedding models may then be evaluated based on how those models score statement/chunks pairs in each group. For instance, when using a distance metric to determine similarity, an accurate embedding model should have, on aggregate, relatively lower distance scores for the group of statement/chunk pairs that are relevant to each other, and should have (again in aggregate) relatively higher distance scores for the group of statement/chunk pairs that are not relevant to each other. A model's aggregate scoring within these groupings that correspond to the statement labels can then be used to evaluate how accurate that embedding model is for the representative sample of documents. In particular embodiments, an LLM may be asked in a prompt to perform the analysis described in this paragraph.

In particular embodiments, machine-learning (ML) metrics may be used to evaluate embedding model performance on the statement/chunk pairs. For example, each embedding performed by a model may be evaluated based on precision, recall, and/or F1 scores, among other metrics. These metrics may be used to determine which embedding models perform well on the representative set of documents, and this determination may be performed by an LLM.

In particular embodiments, an LLM may be asked, via a prompt, to evaluate embedding model performance. For example, a prompt may specify that the LLM is an expert in natural language processing and linguistics. The LLM may be asked to evaluate embedding models' performance based on one or more of (1) a model's embedding similarity scores relative to the LLM's statement/chunk similarity determinations, (2) a model's embedding similarity scores for statement/chunk pairs grouped by classification label, (3) ML metrics, and (4) how well an embedding model captures patterns in the set of paired statement/chunk strings, which patterns may be determined by the LLM. In particular embodiments, an LLM may be asked to, based on one or more of the four factors described above (which may be given respective weights), determine one or more top-performing embedding models, and in particular embodiments, provide an explanation for why that model was determined to be top performing.

In particular embodiments, steps 130 to 160 may be repeated a number of times (e.g., 5 times, although other repetitions may be used), and then step 160 may finally conclude with selecting one or more top performing embedding models from the set of iterations. For example, the top performing embedding model may be the model that appears as the top-ranked model most often in the set of repetitions. As another example, the top performing model may be the model that has the best overall performance in the set of repetitions, as weighted by that model's relative ranking throughout the set of repetitions (e.g., ranking placement may be assigned a score, and the model with the highest or lowest score (depending on whether higher-ranking models are given higher or lower scores, respectively) may then be selected as the top-performing model). As discussed above, particular embodiment may surface the top n performing models, in this example as determined by the set of repetitions of steps 130-160. In particular embodiments, an LLM may take as input the set of repetitions and corresponding rankings for each repetition and determine, via a prompt, which embedding model(s) have the best performance for the representative sample of documents. In particular embodiments, repeating steps 130-160 may reduce the impact of AI-model hallucination (e.g., in the generation of statements and/or in the ranking of models, when an LLM is asked to do the ranking) and/or the impact of random variations in model performance throughout the workflow, for example because embedding models may embed the exact same input differently, and because an LLM's output is typically not entirely determined by an input (e.g., an LLM may provide different output when the same input is provided in different iterations).

Once an embedding model is selected, then the embedding model may be used to embed the entire corpus of documents. As explained above, the techniques described herein efficiently and accurately determine the best embedding model (or best embedding models) to use for a user's particular document corpus and particular AI-assisted tasks, without having to test each embedding model on the entire corpus of documents.

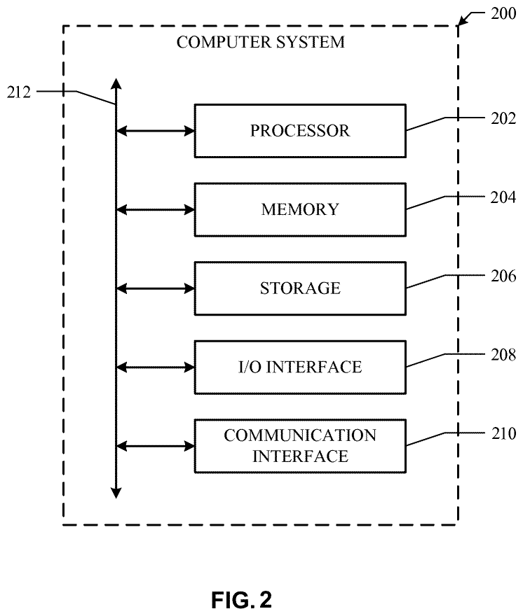

FIG. 2 illustrates an example computer system 200. In particular embodiments, one or more computer systems 200 perform one or more steps of one or more methods described or illustrated herein. In particular embodiments, one or more computer systems 200 provide functionality described or illustrated herein. In particular embodiments, software running on one or more computer systems 200 performs one or more steps of one or more methods described or illustrated herein or provides functionality described or illustrated herein. Particular embodiments include one or more portions of one or more computer systems 200. Herein, reference to a computer system may encompass a computing device, and vice versa, where appropriate. Moreover, reference to a computer system may encompass one or more computer systems, where appropriate.

This disclosure contemplates any suitable number of computer systems 200. This disclosure contemplates computer system 200 taking any suitable physical form. As example and not by way of limitation, computer system 200 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 200 may include one or more computer systems 200; be unitary or distributed; span multiple locations; span multiple machines; span multiple data centers; or reside in a cloud, which may include one or more cloud components in one or more networks. Where appropriate, one or more computer systems 200 may perform without substantial spatial or temporal limitation one or more steps of one or more methods described or illustrated herein. As an example and not by way of limitation, one or more computer systems 200 may perform in real time or in batch mode one or more steps of one or more methods described or illustrated herein. One or more computer systems 200 may perform at different times or at different locations one or more steps of one or more methods described or illustrated herein, where appropriate.

In particular embodiments, computer system 200 includes a processor 202, memory 204, storage 206, an input/output (I/O) interface 208, a communication interface 210, and a bus 212. Although this disclosure describes and illustrates a particular computer system having a particular number of particular components in a particular arrangement, this disclosure contemplates any suitable computer system having any suitable number of any suitable components in any suitable arrangement.

In particular embodiments, processor 202 includes hardware for executing instructions, such as those making up a computer program. As an example and not by way of limitation, to execute instructions, processor 202 may retrieve (or fetch) the instructions from an internal register, an internal cache, memory 204, or storage 206; decode and execute them; and then write one or more results to an internal register, an internal cache, memory 204, or storage 206. In particular embodiments, processor 202 may include one or more internal caches for data, instructions, or addresses. This disclosure contemplates processor 202 including any suitable number of any suitable internal caches, where appropriate. As an example and not by way of limitation, processor 202 may include one or more instruction caches, one or more data caches, and one or more translation lookaside buffers (TLBs). Instructions in the instruction caches may be copies of instructions in memory 204 or storage 206, and the instruction caches may speed up retrieval of those instructions by processor 202. Data in the data caches may be copies of data in memory 204 or storage 206 for instructions executing at processor 202 to operate on; the results of previous instructions executed at processor 202 for access by subsequent instructions executing at processor 202 or for writing to memory 204 or storage 206; or other suitable data. The data caches may speed up read or write operations by processor 202. The TLBs may speed up virtual-address translation for processor 202. In particular embodiments, processor 202 may include one or more internal registers for data, instructions, or addresses. This disclosure contemplates processor 202 including any suitable number of any suitable internal registers, where appropriate. Where appropriate, processor 202 may include one or more arithmetic logic units (ALUs); be a multi-core processor; or include one or more processors 202. Although this disclosure describes and illustrates a particular processor, this disclosure contemplates any suitable processor.

In particular embodiments, memory 204 includes main memory for storing instructions for processor 202 to execute or data for processor 202 to operate on. As an example and not by way of limitation, computer system 200 may load instructions from storage 206 or another source (such as, for example, another computer system 200) to memory 204. Processor 202 may then load the instructions from memory 204 to an internal register or internal cache. To execute the instructions, processor 202 may retrieve the instructions from the internal register or internal cache and decode them. During or after execution of the instructions, processor 202 may write one or more results (which may be intermediate or final results) to the internal register or internal cache. Processor 202 may then write one or more of those results to memory 204. In particular embodiments, processor 202 executes only instructions in one or more internal registers or internal caches or in memory 204 (as opposed to storage 206 or elsewhere) and operates only on data in one or more internal registers or internal caches or in memory 204 (as opposed to storage 206 or elsewhere). One or more memory buses (which may each include an address bus and a data bus) may couple processor 202 to memory 204. Bus 212 may include one or more memory buses, as described below. In particular embodiments, one or more memory management units (MMUs) reside between processor 202 and memory 204 and facilitate accesses to memory 204 requested by processor 202. In particular embodiments, memory 204 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 204 may include one or more memories 204, where appropriate. Although this disclosure describes and illustrates particular memory, this disclosure contemplates any suitable memory.

In particular embodiments, storage 206 includes mass storage for data or instructions. As an example and not by way of limitation, storage 206 may include a hard disk drive (HDD), a floppy disk drive, flash memory, an optical disc, a magneto-optical disc, magnetic tape, or a Universal Serial Bus (USB) drive or a combination of two or more of these. Storage 206 may include removable or non-removable (or fixed) media, where appropriate. Storage 206 may be internal or external to computer system 200, where appropriate. In particular embodiments, storage 206 is non-volatile, solid-state memory. In particular embodiments, storage 206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 206 taking any suitable physical form. Storage 206 may include one or more storage control units facilitating communication between processor 202 and storage 206, where appropriate. Where appropriate, storage 206 may include one or more storages 206. Although this disclosure describes and illustrates particular storage, this disclosure contemplates any suitable storage.

In particular embodiments, I/O interface 208 includes hardware, software, or both, providing one or more interfaces for communication between computer system 200 and one or more I/O devices. Computer system 200 may include one or more of these I/O devices, where appropriate. One or more of these I/O devices may enable communication between a person and computer system 200. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 208 for them. Where appropriate, I/O interface 208 may include one or more device or software drivers enabling processor 202 to drive one or more of these I/O devices. I/O interface 208 may include one or more I/O interfaces 208, where appropriate. Although this disclosure describes and illustrates a particular I/O interface, this disclosure contemplates any suitable I/O interface.

In particular embodiments, communication interface 210 includes hardware, software, or both providing one or more interfaces for communication (such as, for example, packet-based communication) between computer system 200 and one or more other computer systems 200 or one or more networks. As an example and not by way of limitation, communication interface 210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 210 for it. As an example and not by way of limitation, computer system 200 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 200 may include any suitable communication interface 210 for any of these networks, where appropriate. Communication interface 210 may include one or more communication interfaces 210, where appropriate. Although this disclosure describes and illustrates a particular communication interface, this disclosure contemplates any suitable communication interface.

In particular embodiments, bus 212 includes hardware, software, or both coupling components of computer system 200 to each other. As an example and not by way of limitation, bus 212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 212 may include one or more buses 212, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure contemplates a system that includes one or more non-transitory computer readable storage media storing instructions; and one or more processors coupled to the one or more non-transitory computer readable storage media and operable to execute the instructions to perform certain functions includes embodiments in which those functions are performed by a single processor, embodiments in which those functions are performed by multiple processors that each perform all the functions, and embodiments in which those functions are performed by multiple processors (e.g., in separate computing devices) where each processor performs at least one function but less than all recited functions.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

1. A method comprising:
splitting a set of documents into a group of document chunks;
determining a representative sample of the group of document chunks, wherein the sample is representative of that group of chunks;
selecting a set of chunks from the representative sample of the group of document chunks;
for each selected chunk, generating, by a trained AI model, a plurality of statements comprising (1) a first statement whose content is intentionally generated by the AI model to be relevant to the selected chunk and (2) a second statement whose content is intentionally generated by the AI model to be not relevant to the selected chunk;
for each selected chunk and each of the plurality of AI-model generated statements, determining, by each of a plurality of different embedding models, a similarity score between that AI-model generated statement and the selected chunk, wherein each embedding model comprises a different model for embedding content in a vector space; and
selecting, based on the determined similarity scores, at least one particular embedding model from the plurality of different embedding models to use to embed a corpus of documents comprising the set of documents.

2. The method of claim 1, further comprising:
accessing the corpus of documents; and
generating the set of documents by creating a representative sample of documents from the accessed corpus of documents.

3. The method of claim 1, wherein splitting the set of documents into a group of document chunks comprises, for each document in the set of documents:
determining a set of document elements, each document element having an element classification label; and
creating, based on the set of document elements and the corresponding element classification labels, a group of chunks for the respective document.

4. The method of claim 1, wherein determining a representative sample of the group of document chunks comprises:
clustering the group of documents chunks into a plurality of clusters; and
selecting, from each of the plurality of clusters, a sample of document chunks.

5. The method of claim 1, wherein the trained AI model comprises a trained LLM.

6. The method of claim 1, wherein the plurality of statements further comprises a third statement whose content is classified as having moderate relevance to the selected chunk.

7. The method of claim 1, wherein the similarity score comprises a distance in an embedding space.

8. The method of claim 1, further comprising:
repeating the steps of (1) selecting a set of chunks (2) for each selected chunk, generating a plurality of statements and (3) for each selected chunk and each of the plurality of statements, determining, by each of the plurality of embedding models, a similarity score between that statement and the selected chunk; and
selecting, based on the determined similarity scores from the repetitions, the at least one embedding model to use to embed the corpus of documents.

9. The method of claim 8, wherein an LLM selects, based on the determined similarity scores from the repetitions, the at least one embedding model to use to embed the corpus of documents.

10. One or more non-transitory computer readable storage media storing instructions that are operable when executed to:
split a set of documents into a group of document chunks;
determine a representative sample of the group of document chunks, wherein the sample is representative of that group of chunks;
select a set of chunks from the representative sample of the group of document chunks;
for each selected chunk, generate, by a trained AI model, a plurality of statements comprising (1) a first statement whose content is intentionally generated by the AI model to be relevant to the selected chunk and (2) a second statement whose content is intentionally generated by the AI model to be not relevant to the selected chunk;
for each selected chunk and each of the plurality of AI-model generated statements, determining, by each of a plurality of different embedding models, a similarity score between that AI-model generated statement and the selected chunk, wherein each embedding model comprises a different model for embedding content in a vector space; and
select, based on the determined similarity scores, at least one particular embedding model from the plurality of different embedding models to use to embed a corpus of documents comprising the set of documents.

11. The media of claim 10, wherein the instructions are further operable when executed to:
access the corpus of documents; and
generate the set of documents by creating a representative sample of documents from the accessed corpus of documents.

12. A system comprising one or more non-transitory computer readable storage media storing instructions; and one or more processors coupled to the one or more non-transitory computer readable storage media and operable to execute the instructions to:
split a set of documents into a group of document chunks;
determine a representative sample of the group of document chunks, wherein the sample is representative of that group of chunks;
select a set of chunks from the representative sample of the group of document chunks;
for each selected chunk, generate, by a trained AI model, a plurality of statements comprising (1) a first statement whose content is intentionally generated by the AI model to be relevant to the selected chunk and (2) a second statement whose content is intentionally generated by the AI model to be not relevant to the selected chunk;
for each selected chunk and each of the plurality of AI-model generated statements, determining, by each of a plurality of different embedding models, a similarity score between that AI-model generated statement and the selected chunk, wherein each embedding model comprises a different model for embedding content in a vector space;
select, based on the determined similarity scores, at least one particular embedding model from the plurality of different embedding models to use to embed a corpus of documents comprising the set of documents;
access a query from a user regarding the corpus of documents; and
determine, based on the embedded corpus of documents and by a trained AI model, a response to the query.

13. The system of claim 12, further comprising one or more processors that are operable to execute the instructions to:
access the corpus of documents; and
generate the set of documents by creating a representative sample of documents from the accessed corpus of documents.

14. The system of claim 12, wherein splitting the set of documents into a group of document chunks comprises, for each document in the set of documents:
determining a set of document elements, each document element having an element classification label; and
creating, based on the set of document elements and the corresponding element classification labels, a group of chunks for the respective document.

15. The system of claim 12, wherein determining a representative sample of the group of document chunks comprises:
clustering the group of documents chunks into a plurality of clusters; and
selecting, from each of the plurality of clusters, a sample of document chunks.

16. The system of claim 12, wherein the trained AI model that generates the plurality of statements comprises a trained LLM.

17. The system of claim 12, wherein the plurality of statements further comprises a third statement whose content is classified as having moderate relevance to the selected chunk.

18. The system of claim 12, wherein the similarity score comprises a distance in an embedding space.

19. The system of claim 12, further comprising one or more processors that are operable to execute the instructions to:
repeat the steps of (1) selecting a set of chunks (2) for each selected chunk, generating a plurality of statements and (3) for each selected chunk and each of the plurality of statements, determining, by each of the plurality of embedding models, a similarity score between that statement and the selected chunk; and
select, based on the determined similarity scores from the repetitions, the at least one embedding model to use to embed the corpus of documents.

20. The system of claim 19, wherein an LLM selects, based on the determined similarity scores from the repetitions, the at least one embedding model to use to embed the corpus of documents.
